(19) United States
(12) Patent Application Publication
(10) Pub. No.: US 2022/0258450 A1
(43) Pub. Date: Aug. 18, 2022

(54) MULTI-LAYER APPAREL AND ACCESSORY CONSTRUCTION FOR COOLING AND VENTILATION

(71) Applicant: MPUSA, LLC, Fort Lauderdale, FL (US)

(72) Inventor: David Chad LAWRENCE, Alpharetta, GA (US)

(21) Appl. No.: 17/627,897

(22) PCT Filed: Jul. 10, 2020
(86) PCT No.: PCT/US2020/041593

§ 371 Date: Jan. 18, 2022

Related U.S. Application Data
(60) Provisional application No. 62/874,665, filed on Jul. 16, 2019.

(51) Int. Cl. B32B 5/26; B32B 3/26; B32B 5/02; D01D 5/253; D02G 3/38; D02G 3/44; D04B 1/12; D04B 1/24; D04B 21/08; D04B 21/20

(52) U.S. Cl. CPC B32B 5/26; D10B 2403/0213; B32B 5/026; D01D 5/253; D02G 3/38; D02G 3/44; D04B 1/12; D04B 1/24; D04B 21/08; D04B 21/207; B32B 2262/0276; B32B 2262/0261; B32B 2262/0292; B32B 2262/0215; B32B 2437/00; B32B 2307/726; B32B 2307/302; B32B 2250/03; B32B 2250/20; B32B 2262/16; B32B 2262/152; D10B 2331/02; D10B 2331/10; D10B 2331/04; D10B 2501/00; D10B 2401/04; B32B 3/266

(57) ABSTRACT

A cooling garment, and a method of construction thereof, includes: a first layer configured to be adjacent to a wearer's skin and comprising exemplary cooling fabrics capable of providing a conductive cooling effect when preferably when wet-activated; a second layer adjacent to the first layer and comprising a spacer material that allows for convective air flow; and a third layer adjacent to the second layer and comprising perforated holes in order to enhance the airflow to the first and second layers.

### CROSS-REFERENCE TO RELATED APPLICATION

This application claims the benefit of the filing date of, and incorporates by reference thereto in its entirety, U.S. Provisional Patent Application Ser. No. 62/874,665, filed on Jul. 16, 2019.

### TECHNICAL FIELD

The present application relates to a multi-layer apparel and accessory construction for cooling and ventilation, e.g., a garment which provides cooling, and methods of construction thereof.

### BACKGROUND

Users may wear head-covering garments (e.g., hats, headbands, etc.) for a number of practical reasons. For example, the head-covering garment can be used to provide necessary shade for the user. Further, the head-covering garment can also be used as an absorbent material, e.g., to absorb sweat or other liquids. However, during particularly hot conditions, such as increased physical activity and/or as a result of external atmospheric conditions (e.g., warm/hot weather), many of the current head-covering garments fail to provide adequate cooling for the wearer.

Accordingly, there is a need for a solution which can overcome at least some of the deficiencies described herein.

### SUMMARY

An exemplary garment includes a plurality of different materials that can provide an overall cooling effect. For example, a first layer (104) can be adjacent to a wearer's skin and can include cooling fabrics capable of providing a conductive cooling effect, e.g., when wet through evaporative cooling or, alternatively, in a dry state. Further, a second layer (106) can be adjacent to the first layer and can include a spacer material, which can allow for convective air flow, thereby aiding in the evaporation of liquid from the first layer as well as enhancing the conductive cooling of the skin adjacent to the first layer. Further, a third layer (108) can be adjacent to the second layer and can include perforated holes in order to enhance the airflow to the first and second layers. In addition, the third layer can correspond to the outer shell of the exemplary garment.

The evaporative cooling effect of material/construction 100 in FIGS. 1A and 1B is activated when the material/construction 100 is wetted, wringed, snapped and/or twirled in the air. The cooling effect for the material 100 described herein utilizes the principles of evaporative cooling (heat of evaporation). This principle states that water requires heat energy to change from a liquid into a vapor. In order for evaporation to occur, heat must be taken from the liquid water, which leaves cooler liquid in material 100.

Once material 100 is wetted and preferably wringed to remove excess water, snapping or twirling in the air is a recommended process as it helps facilitate and expedite the moisture movement from the inside 104 to the outside layers 106 and 108, where greater water evaporation to the environment occurs. Snapping or twirling in the air also increases the evaporation rate and decreases the material temperature more rapidly by exposing more surface area of material 100 to air and increasing airflow. More specifically, the material 100 works as a device that facilitates and expedites the evaporative process. The methods of making material 100 described herein provide additional benefits of cooling over alternative constructions. Once the temperature of the remaining water in the outer evaporative layers (e.g., sides 104 and 108) drops through evaporation, a heat exchange takes place within water through convection, between water and material 100 through conduction, and within material 100 through conduction. Thus, the temperature of material 100 drops. The evaporation process further continues by wicking water away from the inside to the outside layers until the stored water is used up. The evaporation rate decreases as the temperature of material drops. The temperature of material 100 drops gradually to a certain point where equilibrium is reached between the rate of heat absorption into material from the skin and heat release by evaporation.

Once the wetted material 100 is placed onto a user's skin 102, material 100 transfers heat through conduction from skin surface 102 to side 104. After the heat transfer has occurred, the temperature of material 100 increases to equilibrate with the temperature of skin surface 102. Once this occurs, the wetted material 100 can easily be reactivated by the snapping or the twirling method to again drop the temperature. As previously stated, the methods of making material 100 described herein provide additional benefits of cooling over other materials.

Material 100 can also be activated through the saturation of sweat. As a user sweats, the inside 104 absorbs the sweat or moisture from skin surface 102. The user can use material 100 in this manner until the textile has become completely saturated. Then, to reactivate material 100, it can be wringed and twirled in air to reactivate. The user's sweat can be used to activate material 100.

To help produce the unique cooling effect of material/construction 100, a first layer 104 includes either predominately polyester or nylon yarns with an optional modified cross-section yarn imbedded with cooling minerals (or particles), which act to transport and evaporate moisture while providing a cool touch. Example particles and/or include titanium dioxide, mica, jade, and graphene. The second layer 106 includes either predominately polyester or nylon yarn with spacer material which can allow for convective air flow, thereby aiding in the evaporation of liquid from the first layer as well as enhancing the conductive cooling of the skin adjacent to the first layer. The third layer 108 can include a plurality of vent pores (e.g., perforated holes) which provide convective cooling through ventilation and evaporation. The material used in the third layer can be synthetic fiber such as polyester or nylon so that this layer can be laser perforated which allows for greater breathability.

An exemplary garment or accessory includes: a first layer, in which the first layer includes a plurality of synthetic filament yarn with a modified cross-section; a second layer, in which the second layer includes another plurality of synthetic filament yarn in a mesh construction; and a third layer, in which the third layer includes a plurality of perforated holes. The first layer and/or the second layer may be constructed with a circular knitting construction.

The first layer and/or the second layer may be constructed with a warp knitting construction.

The synthetic filament yarn may include polyester and/or nylon.

The plurality of synthetic filament yarn in the first layer may include: (i) 70%-100% of polyester or nylon and (ii) 0%-30% of spandex.

The first layer may have (i) a cumulative heat flux of at least 5,000 W/m² and (ii) a Q-max rating of greater than 0.130 W/cm².

The first layer may include embedded particles and/or embedded minerals.

At least one other synthetic filament yarn may cover the synthetic filament yarn.

The at least one other synthetic filament yarn may cover the synthetic filament yarn by a single-covered manner, a double-covered manner, and/or an air jet covering technique.

The synthetic filament yarn may be wrapped with the at least one other synthetic filament yarn and spun to create a single yarn.

A pile height of the synthetic filament yarn in the second layer may be at least 1 mm.

The first layer, the second layer and third layer may provide: cooling power that is 40% greater than normal garment constructions as measured by the modified ASTM Method F1868; instant cool touch as defined as Q-max≥0.130 when dry and ≥0.180 when wet; and when wet-activated, (i) wicking and absorbent ability allows for a temperature decrease of thirty degrees below body temperature and (ii) a duration of the cooling can extend to approximately two hours depending on external humidity/temperature conditions.

The second layer may be arranged between the first layer and the third layer.

A first side of the first layer may be adapted to touch a wearer's skin, a second side of the first layer may be arranged opposite a first side of the second layer, a second side of the second layer may be arranged opposite a first side of the third layer, and a second side of the third layer may be adapted to be exposed to the environment.

An exemplary garment or accessory, includes: a first layer, a second layer, and a third layer. The first layer includes a single knit jersey construction weighing 190±20 gsm with a fiber content of 92%±5% polyester yarns and 8%±5% spandex yarns; the polyester yarns include a modified cross-section for increased capillary action and evaporative ability; the polyester yarns are embedded with particles for adding a cool touch effect as defined by Q-max≥0.130 when dry and Q-max≥0.180 when wet; and the polyester yarns include a yarn filament count of greater than 24 filaments per end of polyester yarn. The second layer includes another plurality of synthetic filament yarn including spacer material in a mesh construction, in which: the spacer material includes a breathability of greater than 800 MVTR; the spacer fabric is between 100 gsm and 500 gsm; a pile height of the spacer material is at least one millimeter; and the spacer material is infused with cooling yarns including aqua-X, mipan XF or askin. The third layer includes a plurality of perforated holes, in which the third layer includes a rip stop material weighing less than 150 grams per square meter (gsm) and polyester or nylon.

An exemplary garment or accessory includes: a first layer including at least 80% polyester yarns with modified cross-section yarn imbedded with cooling minerals, the cooling materials being titanium dioxide, mica, jade, and/or graphene; a second layer including at least 80% nylon yarns with spacer material which allows for convective air flow and weighs between 100 gsm and 500 gsm; and a third layer including polyester yarns and a plurality of vent pores, the third layer weighing less than 150 grams per square meter.

### BRIEF DESCRIPTION OF THE DRAWINGS

FIG. 1A illustrates an exemplary garment.

FIG. 1B illustrates layers of an exemplary garment.

FIGS. 2A-2E illustrate exemplary warp knit constructions.

FIG. 3 illustrates a second layer of an exemplary garment.

FIGS. 4A-4C illustrate cross-sectional views of synthetic filament yarns.

FIGS. 5A-5D illustrate exemplary covered synthetic filament yarns.

FIG. 6 illustrates an exemplary garment.

### DESCRIPTION OF EMBODIMENTS

The following description of embodiments provides non-limiting representative examples referencing numerals to particularly describe features and teachings of different aspects hereof. The embodiments described should be recognized as capable of implementation separately, or in combination, with other embodiments from the description of the embodiments. A person of ordinary skill in the art reviewing the description of embodiments should be able to learn and understand the different described aspects of this disclosure. The description of embodiments should facilitate understanding of these embodiments to such an extent that other implementations, not specifically covered but within the knowledge of a person of skill in the art having read this description, would be understood to be consistent with an application of these embodiments.

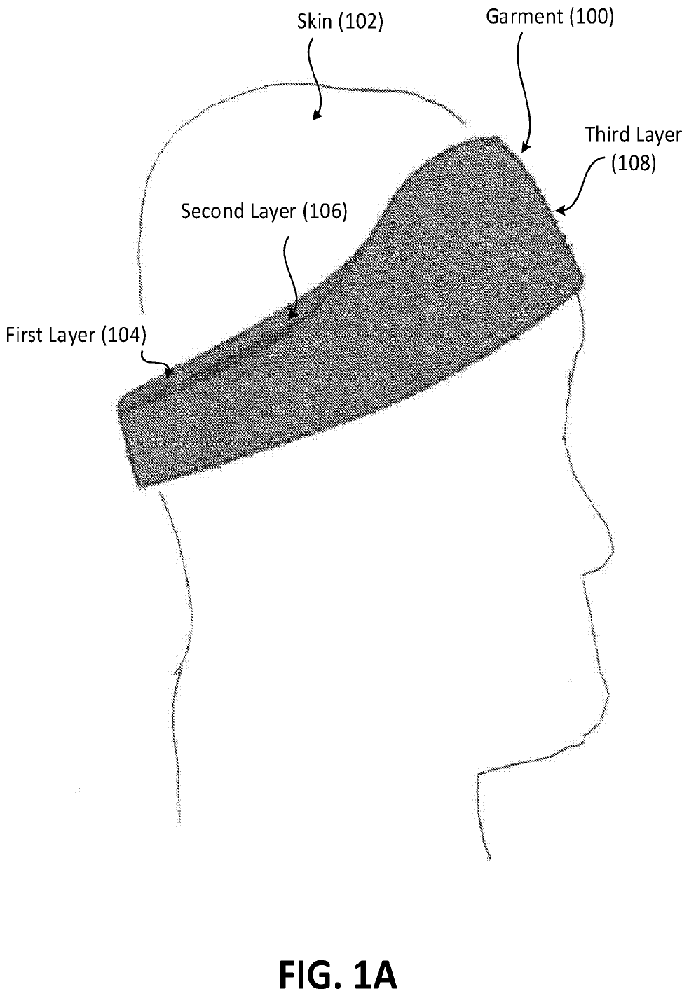

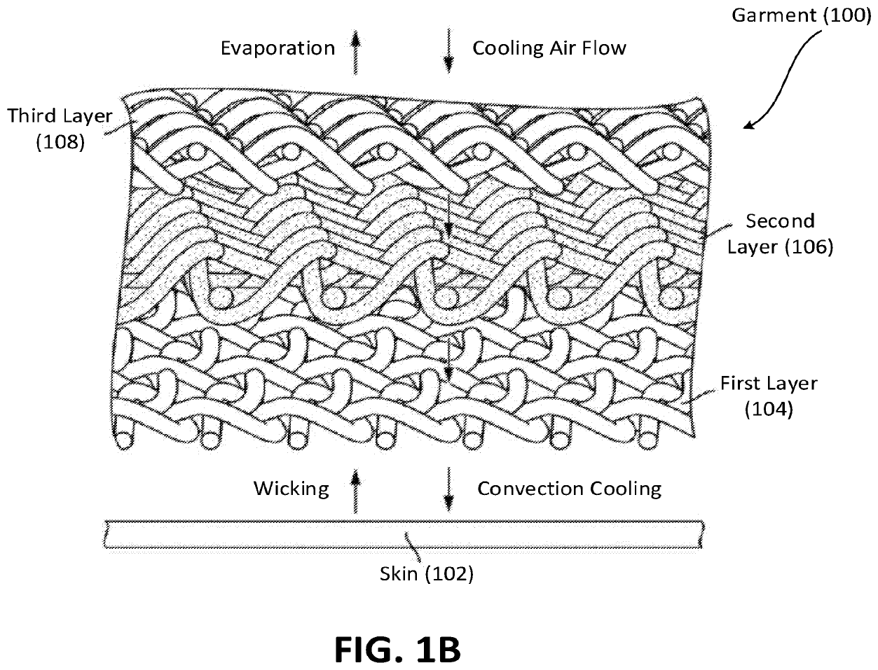

FIG. 1A illustrates an exemplary garment. As depicted in the FIG. 1A, exemplary garment 100 can be a headband. However, in other embodiments, the exemplary garment can be a shirt, a pair of shorts, a towel, a hat, etc. According to an embodiment, the exemplary garment 100 can include a first layer 104, a second layer 106, and a third layer 108, which are depicted in more detail in FIG. 1B.

According to an embodiment, the first layer 104 can be adjacent to the skin 102 of a particular user. Further, the first layer 104 can include synthetic yarn. For example, the first layer 104 can include modified cross-section synthetic filament yarn to aid in the moisture transport and evaporation. The modified cross-section can be a cross-section other than round which can include but not limited to: trilobal, rectangular, dog-bone, or in cloud shapes. In general, modified cross-sections in yarn can increase the spread of moisture which increases the surface area spread and the evaporative effect of the yarn over non-modified (rounded) cross-section yarn. These yarns can also contain embedded cooling particles (e.g., titanium dioxide, jade, mica, and/or graphene) to increase the Q-max rating (instant cool touch) of the first layer 104. In this regard, the Q-max can be greater than 0.130 W/cm². Further, the cumulative cooling power of the first layer 104 can exceed a heat flux of 5,000 W/m² (watts per square meter) based on a modified version of the ASTM F1868 entitled “Standard Test Method for Thermal and Evaporative Resistance of Clothing Materials Using a Sweating Hot Plate.” Further, the weight range of the first layer 104 can be between 20 gsm (grams per square meter) to 500 gsm.

According to an embodiment, the first layer 104 can include a single knit jersey construction weighing approximately 190 gsm with a fiber content of approximately 92% polyester and 8% spandex. According to another embodiment, the fiber content can range from 70%-100% polyester or nylon and 0%-30% spandex. In this regard, the corresponding yarns can be evaporative polyester and can include (i) a modified cross-section for increased capillary action and evaporative ability and (ii) embedded particles/minerals for adding a cool touch (e.g., Q-max) effect. Further, the first layer 104 can include a yarn filament count of greater than 24 filaments per end of polyester or nylon yarn used.

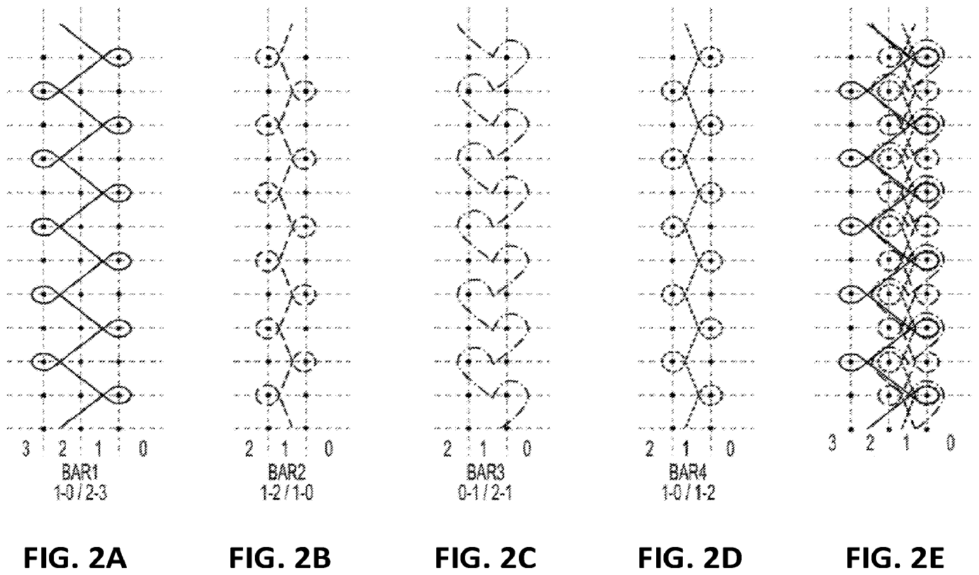

Further, according to another embodiment, the first layer 104 can be constructed using a warp knitting method. Warp knits include, but are not limited to, tricot, raschel, spacer, and lace. A first example for warp knit tricot 4-bar construction, depicted in FIGS. 2A-2E, utilizes the following stitch and yarn combinations: FIG. 2A—Bar 1—1-0/2-3 (evaporative yarn such as aqua-X); FIG. 2B—Bar 2—1-2/1-0 (absorbent yarn such as mipan XF); FIG. 2C—Bar 3—0-1/2-1 (evaporative yarn such as askin); and FIG. 2D—Bar 4—1-0/1-2 (elastic yarn such as spandex). According to an embodiment, bar 1 is a 35 Denier/24 filament nylon fully drawn yarn or draw textured yarn; bar 2 is a 50 Denier/48 filament conjugated polyester/nylon bi-component fully drawn yarn; bar 3 is a 75 Denier/36 filament polyester draw textured yarn; and bar 4 is a 40 Denier spandex. This configuration results in a fabric having a density of 100-600 gsm, e.g., 160-400 gsm. The combined first layer 104 resulting from this stitch is depicted in FIG. 2E. Further, The yarn Deniers and filament counts used on bars 1-4 can be varied using the following ranges: bar 1: evaporative yarn with Denier range—10 Denier-200 Denier, filament range—1 filament-400 filaments; bar 2: absorbent yarn with denier range—10 Denier-200 Denier, filament range—1 filament-400 filaments; bar 3: evaporative yarn with Denier range—10 Denier-200 Denier, filament range—1 filament-400 filaments; and bar 4: elastomeric yarn with Denier range—10 Denier-340 Denier. As another example, bar 2 may utilize a yarn such as Nanofront polyester yarn manufactured by Teijin which has significantly smaller filaments than traditional absorbent yarns. Another embodiment of the first layer 104 can use the following 4-bar knitting stitch and yarn combination: bar 1—1-0/2-3 (evaporative yarn such as askin); bar 2—1-2/1-0 (absorbent yarn such as Hyosung mipan XF); bar 3—0-1/2-1 (evaporative yarn such as askin); and bar 4—1-0/1-2 (elastic yarn such as spandex). In this stitch configuration, bar 1 is a 45 Denier/24 filament polyester fully drawn yarn; bar 2 is a 50 Denier/48 filament polyester and nylon conjugated fully drawn yarn; bar 3 is a 75 Denier/36 filament polyester draw textured yarn; and bar 4 is a 40 Denier spandex. In both knitting stitch examples, bars 1 and 3 are cool touch/quick dry/absorption materials as have already been described. The Q-max for these yarns is greater than 0.140 W/cm² on the face side and 0.120 W/cm² on the back side of the material which indicates a cooling touch effect as has already been described. The wet Q-max for these yarns is greater than 0.280 W/cm² on face side and 0.180 W/cm² on back side. Bar 2 is a conjugated highly absorbent yarn (mipan XF) which has a wicking rate and a wicking distance more than twice that of cotton of equivalent density. The spandex yarn provides hydrophobic properties, provides stretch properties, and a draping effect. Further, according to an embodiment, the warp knit patterns described with respect to FIGS. 2A-2E can be modified. For example, in FIG. 2A, bar 1—0/2-3 can be modified to 1/0-3/4.

Further, the first layer 104 can also be constructed using a warp knit spacer. A warp knit spacer machine can insert additional yarns such as a mono-filament yarn to provided added thickness to the first layer 104. This added thickness created by yarns such as mono-filament yarns can be substituted or combined intermittently with conjugate yarn while the outside yarns used can be highly evaporative yarns or other yarns. Further, the first layer 104 can also be constructed using a warp knit jacquard. A warp knit jacquard can be utilized to create unique patterns such as but not limited to lace, fancy knits, mesh, body mapped, and other three-dimensional designs. Warp knit jacquard can creatively place highly evaporative yarns with highly absorbent yarns within the same construction to create a uniquely designed cooling fabric with or without patterns such as mesh and graphics.

Further, the first layer 104 can be constructed using a spacer implementing a circular knitting method. For example, the first layer 104 can be constructed using a circular knit spacer machine. A circular knit spacer machine can insert additional yarns such as a mono-filament yarn to provided added thickness to the material of the first layer 104. This added thickness created by yarns such as monofilament yarn can be substituted or combined intermittently with conjugate yarn while the outside yarns can be highly evaporative yarns or any other yarns. Further, the first layer 104 can also be achieved using a circular knit interlock, ponte, or pique constructions. A circular knit interlock machine can insert additional evaporative and absorbent yarns to provide added evaporative cooling ability to the fabric. The first layer 104 can also be achieved using a circular knit jacquard. A circular knit jacquard can be utilized to create unique patterns, such as, but not limited to, fancy knits, mesh, body-mapped patterns, and other three-dimensional designs. Circular knit jacquard can creatively place highly evaporative yarns with highly absorbent yarns within the same construction to create a uniquely designed cooling fabric with or without patterns such as mesh and graphics.

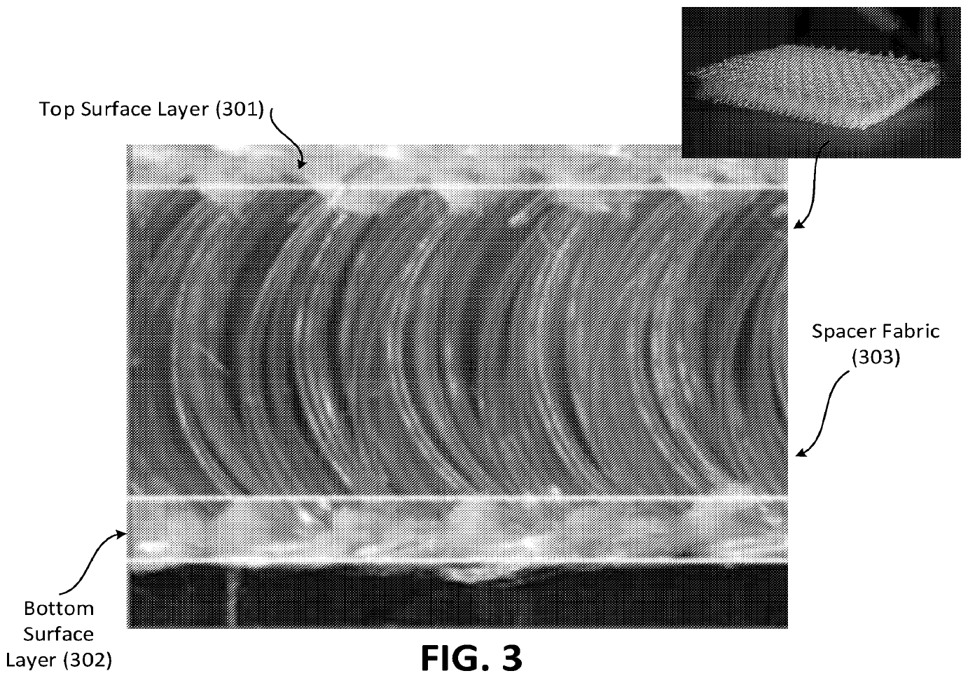

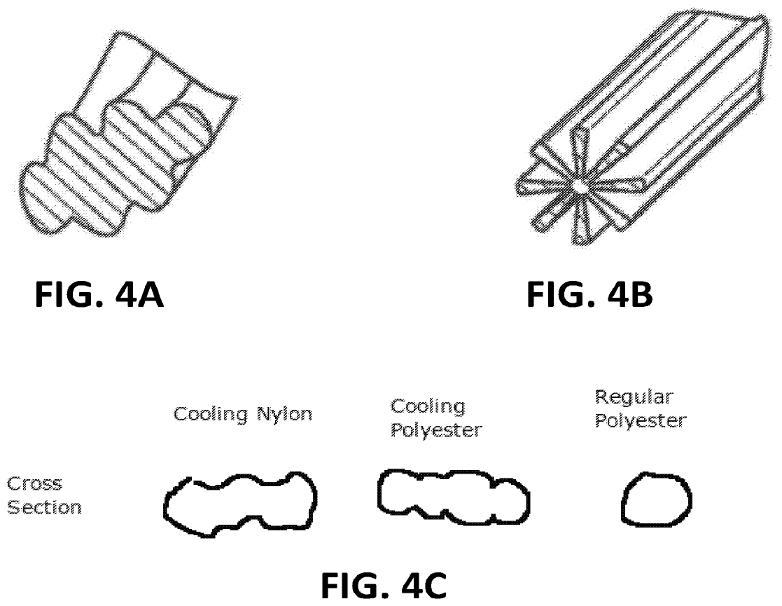

According to an example embodiment, the second layer 106 can include a spacer fabric construction, as depicted in FIG. 3. In this example, the second layer 106 can include a top surface layer 301, a bottom surface layer 302 and spacer fabric 303. The spacer fabric 303 in the second layer 106 can include a breathability (as tested by ASTM E96) of greater than 800 MVTR (e.g., moisture vapor transfer rate) within twenty-four hours. The spacer fabric can be knitted using a mesh construction at least on one side (e.g., top surface layer 301 or bottom surface layer 302) of the second layer 106 in order to allow for air pockets and greater air flow. Further, the weight range for the spacer fabric can be between 100 gsm and 500 gsm. Further, the pile height of the spacer fabric can be at least one millimeter (mm). Further, the spacer fabric can also be infused with cooling yarns which allow for greater evaporation and cool touch over other materials. The yarns used can be an inner evaporative nylon yarn such as aqua-X, a middle absorbent bi-component nylon/polyester yarn such as mipan XF) and an outer evaporative polyester yarn such as askin. Exemplary yarns which can be used as spacer fabric are depicted in FIGS. 4A and 4B. Further, according to an embodiment, the spacer fabric can be constructed using one of the circular knitting method or warp knitting method described above.

According to an example embodiment, layers 104 and 106 can comprise of a Dual Function Absorbing and Cooling Textile as described, for example, in PCT/US19/15239, which is expressly incorporated herein in its entirety by reference thereto. For example, the dual function ability of this textile can replace both layers 104 and 106. This Dual Function Absorbing and Cooling textile is a warp knit spacer textile that provides a dual function two-sided textile capable of absorbing up to four times its weight in perspiration on a loop absorbent side. Also, while wetted to activate, the same textile can provide increased conductive cooling on a non-loop (flat) absorbent side. More particularly, the multi-layer warp knit spacer fabric construction provides the ability to absorb sweat efficiently away from the skin while the same textile can be used to cool the skin to below a current temperature of the skin for a longer duration, primarily when wetted, but secondarily in dry state. Described in PCT/US19/15239 is an integrally formed warp knitted spacer structure that includes four bars of yarn which collectively work together to produce the textile.

According to an embodiment, the third layer 108 can correspond to the outer shell of the garment 100 and can include a plurality of vent pores (perforated holes) which can provide convective cooling through ventilation and evaporation. The material used in the third layer can be a rip stop material weighing less than 150 grams per square meter (gsm) and includes, for example, synthetic fiber such as polyester or nylon so that this layer can be laser perforated which allows for greater breathability. The weight range of this third layer material can be anywhere from 10 gsm to 400 gsm. It can also be constructed using any woven pattern or knit pattern material within the weight range of 10 gsm to 400 gsm. This material allows for ventilation to the inner hat band layer either by high breathability, through perforations, or other mechanisms.

FIGS. 4A-4B illustrate cross-sectional views of synthetic filament yarns according to exemplary embodiments. For example, FIG. 4A depicts a synthetic filament yarn (e.g., polyester and/or nylon) having a unique cross section. According to an embodiment, the unique cross section creates channels in the yarn for moisture to move and evaporate more quickly. Furthermore, this unique yarn allows for better evaporation and therefore provides greater evaporative cooling for the described embodiments. Further, FIG. 4B depicts a synthetic filament yarn having a star-shaped cross section. In this regard, the star-shaped cross section provides a higher absorbency, and therefore, holds water more efficiently. This unique yarn can provide greater liquid absorption for the materials used herein, which can be used in combination with evaporative yarns to provide a longer evaporative cooling effect. According to an embodiment, a differentiated cross section helps moisture move and spread to the outer layer of the fabric. Further, the synthetic filament yarn can also include absorbent microdenier yarn. According to an embodiment, the absorbent microdenier yarn can be less than 1 denier per filament (dpf). Further, the absorbent microfiber yarn can use multiple filaments (e.g., 72 filaments) to provide absorbent properties. Further, according to another embodiment, conjugated bi-component special cross-section yarn can be used to provide extreme absorbent properties. Further, by splitting the yarn, more surface area, and therefore, more pockets can be created for absorbency. Further, FIG. 4C depicts the cross-sections of cooling nylon, cooling polyester, and regular polyester.

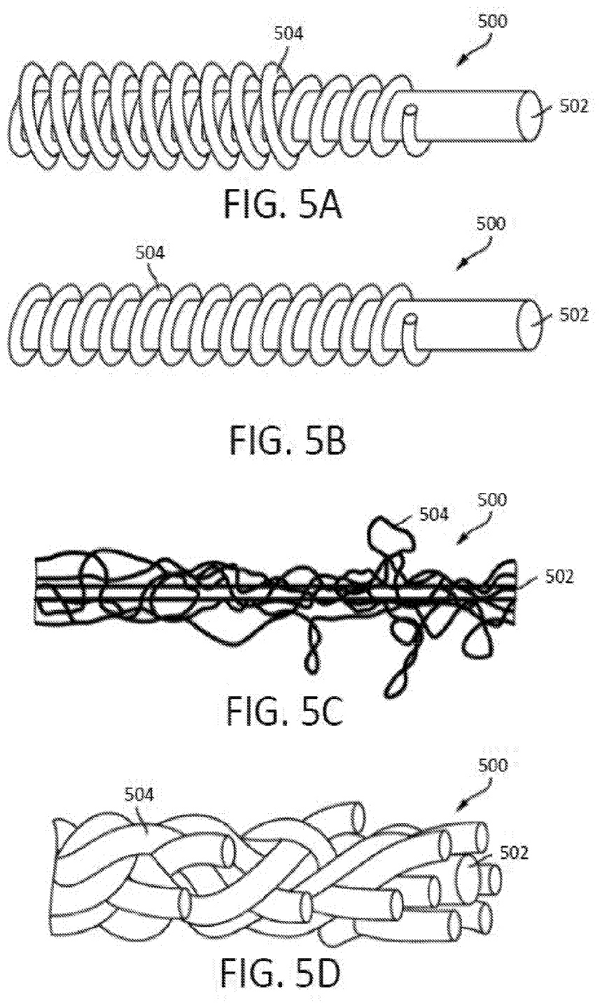

FIGS. 5A-5D illustrates exemplary covered synthetic filament yarn. For example, FIG. 5A illustrates a double-covered synthetic filament yarn. In particular, FIG. 5A depicts a covered synthetic filament yarn 500 including a core predominately synthetic spun or filament yarn 502 being covered by another synthetic filament yarn 504 in a double-covered manner. FIG. 5B illustrates a single-covered synthetic filament yarn. In this regard, FIG. 5B depicts the core predominately synthetic spun or filament yarn 502 being covered by another synthetic filament yarn 504 in a single-covered manner. Further, FIG. 5C illustrates an air jet-covered synthetic filament yarn. In this regard, FIG. 5B depicts the core predominately synthetic spun or filament yarn 502 being covered by another synthetic filament yarn 504 via air jet covering technique. Lastly, FIG. 5D illustrates a core-spun synthetic filament yarn. In this regard, the core predominately synthetic spun or filament yarn 502 is wrapped with other synthetic filament yarn 504 and spun into a single yarn 500. The list in Table 1 below describes possible combinations of a core synthetic filament yarn 502 and another synthetic filament yarn 504.

TABLE 1

| | | Total Estimated |
|---|---|---|
| Core Yarn | Covered Yarn | Denier |
| 30 Ne | Synthetic Filament Evaporative | 327 Denier Total |
| 80% Polyester/20% | Cooling Polyester 150 | (Single covered) |
| Tencel Spun Yarn | Denier/72 Filaments Draw | |
| Blend | Textured Yarn (DTY) | |
| 30 Ne | Synthetic Filament Evaporative | 317 Denier total |
| 80% Polyester/20% | Cooling Polyester 2 ply/70 | (Single covered |
| Tencel Spun Yarn | Denier/26 Filament Fully | yarn) |
| Blend | Drawn Yarn (FDY) | |
| 30 Ne | Synthetic Filament Evaporative | 317 Denier total |
| 80% Polyester/20% | Cooling Nylon 140 Denier/136 | (Single covered |
| Tencel Spun Yarn | Filament Draw Textured Yarn | yarn) |
| Blend | (DTY) | |
| 30 Ne | Synthetic Filament Evaporative | 317 Denier total |
| 80% Polyester/20% | Cooling Nylon 2 ply/70 | (Single covered |
| Tencel Spun Yarn | Denier/48 Filament Fully | yarn) |
| Blend | Drawn Yarn (FDY) | |

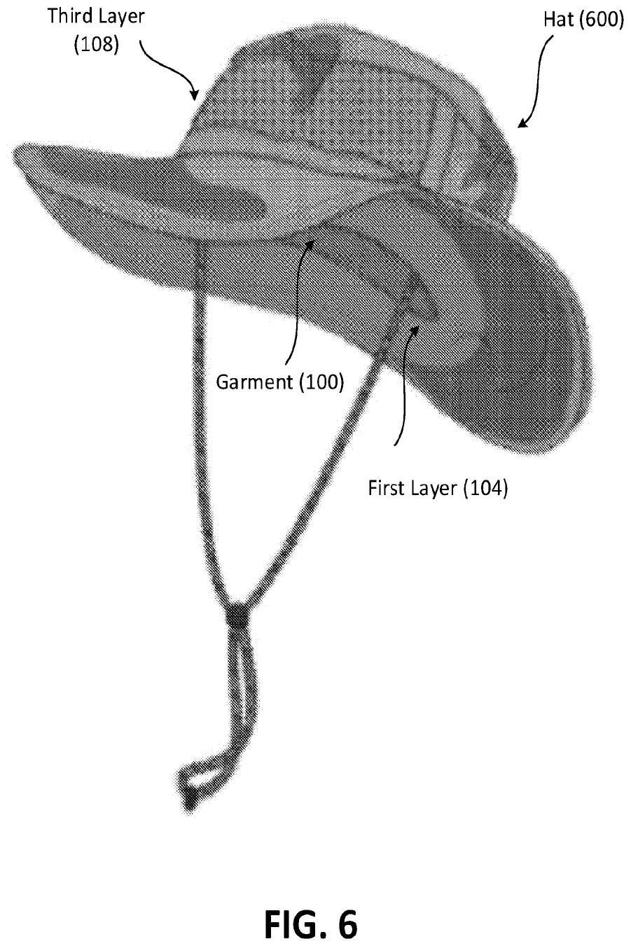

FIG. 6 illustrates an exemplary garment. In particular, FIG. 6 depicts the exemplary garment 100 as a hat 500. In this example embodiment, the hat 600 can include the garment 100 including the first, second and third layers 104, 106 and 108. The first layer 104 and the third layer 108 are displayed in the FIG. 6.

According to an embodiment, the exemplary garment 100 can provide the following advantages: cooling power that is 40% greater than normal garment constructions as measured by the modified ASTM Method F1868; instant “cool touch” as defined as Q-max≥0.130 when dry and >0.180 when wet; increased air ventilation and breathability, which helps enhance conductive and convective cooling; and, when wet-activated, (i) the wicking and absorbent ability allows for a temperature decrease of thirty degrees below body temperature and (ii) the duration of the cooling can extend to approximately two hours depending on external humidity/temperature conditions.

The garment as described herein may form a portion of a sun protection device, such as that described in U.S. Pat. No. 9,402,432, which is expressly incorporated herein in its entirety by reference thereto. In particular, a drape (or other portion) of such a sun protection device may be formed of the garment described herein. Moreover, the drape (or other portion) of such a sun protection device may be formed of the textile described in PCT/US19/15239, the textile and/or fabric described in U.S. patent application Ser. No. 16/077,353, the fabric described in U.S. patent application Ser. No. 16/100,939, the fabric described in U.S. patent application Ser. No. 16/749,016, and/or the fabric described in PCT/US2020/014529, each of which is expressly incorporated herein in its entirety by reference thereto.

In the foregoing description, various features may be grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated herein, with each claim standing on its own as a separate embodiment of this disclosure.

Moreover, it will be apparent to those skilled in the art from consideration of the specification and practice of the present disclosure that various modifications and variations can be made to the disclosed systems without departing from the scope of the disclosure, as claimed. Thus, it is intended that the specification and examples be considered as exemplary only, with a true scope of the present disclosure being indicated by the following claims and their equivalents.

1. A garment or accessory, comprising:
a first layer, wherein the first layer includes a plurality of synthetic filament yarn with a modified cross-section;
a second layer, wherein the second layer includes another plurality of synthetic filament yarn in a mesh construction; and
a third layer, wherein the third layer includes a plurality of perforated holes.

2. The garment or accessory according to claim 1, wherein at least one of the first and second layers is constructed with a circular knitting construction.

3. The garment or accessory according to claim 1, wherein at least one of the first and second layers is constructed with a warp knitting construction.

4. The garment or accessory according to claim 1, wherein the synthetic filament yarn is one of polyester or nylon.

5. The garment or accessory according to claim 4, wherein the plurality of synthetic filament yarn in the first layer includes: (i) 70%-100% of polyester or nylon and (ii) 0%-30% of spandex.

6. The garment or accessory according to claim 1, wherein the first layer has (i) a cumulative heat flux of at least 5,000 W/m² and (ii) a Q-max rating of greater than 0.130 W/cm².

7. The garment or accessory according to claim 1, wherein the first layer includes at least one of embedded particles or embedded minerals.

8. The garment or accessory according to claim 1, further comprising:
at least one other synthetic filament yarn covering the synthetic filament yarn.

9. The garment or accessory according to claim 8, wherein the at least one other synthetic filament yarn covers the synthetic filament yarn via one of a single-covered manner, a double-covered manner, and an air jet covering technique.

10. The garment or accessory according to claim 8, wherein the synthetic filament yarn is wrapped with the at least one other synthetic filament yarn and spun to create a single yarn.

11. The garment or accessory according to claim 1, wherein a pile height of the synthetic filament yarn in the second layer is at least 1 mm.

12. A garment or accessory according to claim 1, wherein the first layer, the second layer and third layer provide:
cooling power that is 40% greater than normal garment constructions as measured by the modified ASTM Method F1868;
instant cool touch as defined as Q-max≥0.130 when dry and ≥0.180 when wet; and
when wet-activated, (i) wicking and absorbent ability allows for a temperature decrease of thirty degrees below body temperature and (ii) a duration of the cooling can extend to approximately two hours depending on external humidity/temperature conditions.

13. The garment or accessory according to claim 1, wherein the second layer is arranged between the first layer and the third layer.

14. The garment or accessory according to claim 1, wherein a first side of the first layer is adapted to touch a wearer's skin, a second side of the first layer is arranged opposite a first side of the second layer, a second side of the second layer is arranged opposite a first side of the third layer, and a second side of the third layer is adapted to be exposed to the environment.

15. A garment or accessory, comprising:
a first layer, wherein:
the first layer includes a single knit jersey construction weighing 190±20 gsm with a fiber content of 92%±5% polyester yarns and 8%±5% spandex yarns;
the polyester yarns include a modified cross-section for increased capillary action and evaporative ability;
the polyester yarns embedded with particles for adding a cool touch effect as defined by Q-max≥0.130 when dry and Q-max≥0.180 when wet; and
the polyester yarns include a yarn filament count of greater than 24 filaments per end of polyester yarn;
a second layer, wherein the second layer includes another plurality of synthetic filament yarn including spacer material in a mesh construction, wherein:
the spacer material includes a breathability of greater than 800 MVTR;
the spacer fabric is between 100 gsm and 500 gsm;
a pile height of the spacer material is at least one millimeter; and
the spacer material is infused with cooling yarns including aqua-X, mipan XF or askin; and
a third layer, wherein the third layer includes a plurality of perforated holes, wherein the third layer is comprised of a rip stop material weighing less than 150 grams per square meter (gsm) and polyester or nylon.

16. A garment or accessory, comprising:
a first layer including at least 80% polyester yarns with modified cross-section yarn imbedded with cooling minerals, the cooling materials being titanium dioxide, mica, jade, or graphene;
a second layer including at least 80% nylon yarns with spacer material which allows for convective air flow and weighs between 100 gsm and 500 gsm; and
a third layer including polyester yarns and a plurality of vent pores, wherein the third layer weighs less than 150 grams per square meter.
